(19) United States
(12) Patent Application Publication
(10) Pub. No.: US 2009/0144902 A1
(43) Pub. Date: Jun. 11, 2009

(54) MEDICAL EXAMINATION TABLE

(76) Inventors: Berthold Baumann, Kastl (DE); Franz Dirauf, Ebensfeld (DE)

Correspondence Address: BRINKS HOFER GILSON & LIONE, P.O. BOX 10395, CHICAGO, IL, 60610, US

(21) Appl. No.: 12/328,250

(22) Filed: Dec. 4, 2008

(30) Foreign Application Priority Data
Dec. 11, 2007 (DE) 10 2007 059 520.6

(51) Int. Cl. A61G 13/04; A61G 13/10

(52) U.S. Cl. 5/608; 700/60

(57) ABSTRACT

A medical examination table for accommodating a patient is provided. The medical examination table includes a table top. The table includes at least one measuring device which measures a tilting of the table top induced by weight load. The value of the measured tilt is used for automatic tilt compensation of the table top or for setting a predefinable tilt of the table top. Load-dependent deformations of the medical examination table, caused for example by the weight of the patient, can be automatically corrected.

This patent document claims the benefit of German Patent Application No. DE 10 2007 059 520.6 filed on Dec. 11, 2007, which is hereby incorporated by reference.

### BACKGROUND

The present embodiments relate to a medical examination table.

Medical examination tables are used, for example, as patient examination couches (tables) for accommodating patients during medical examinations or for operative interventions.

Patient examination couches are used, for example, in conjunction with x-ray equipment, computed tomography scanners and magnetic resonance devices. The table top of the patient examination table is mounted movably relative to a table plinth in order to enable a patient lying on the table top to be positioned in a desired or required manner relative to the x-ray device. The table top can be displaced manually. Accordingly, the table top is typically mounted in a floating manner. Additionally, the table top can be moved automatically by a motor. A type of joystick, for example, is provided for control purposes, with the movement of the joystick determining how an open- or closed-loop control device is to control the motor to produce the desired table top movement.

To enable switching between a motorized and manual table top displacement, a clutch that it is necessary to actuate manually is provided for decoupling the table top from the drive train to the motor. The clutch is arranged in the drive train after the gearing mechanism in order to avoid the user's having to move the entire gearing mechanism during the manual displacement of the table top, which operation involves an even higher expenditure of force in addition to the effort that has to be made in typical situations in any case.

With manual displacement, the displacing force is applied and initiated exclusively by the user (operator). The displacing force requiring to be applied is dependent on the weight (e.g., how heavy) of the patient lying on the table top. For example, more applied force is needed in order to move a heavy patient than is necessary in the case of a light patient. Accordingly, to realize a table top displacement that is both manageable and also suitable for use by physically weaker persons even when it comes to dealing with heavy patients, the bearing units by way of which the table top is movably mounted are implemented as free-running.

A manual displacement is generally possible only with the table top in a horizontal position. The table top has to be tilted or canted in order to orientate the patient in an optimal manner relative to the imaging device. A manual table top displacement is not possible because the displacing force requiring to be applied, which it would be necessary to expend, for example, in order to raise the tilted or canted table top together with the patient being accommodated, is great and consequently cannot be managed as a rule. Automatic, motor-driven table top displacement presents itself as the only suitable solution.

German patent specification DE 10 2006 008 505 A1 describes a patient examination table.

A loading of the table superstructure or a table top can amount to as much as 300 kg in typical applications. The loading may include a patient weight of up to 200 kg and accessory weight up to 100 kg. The loading weight can cause the table top to distort or to assume an undesirable tilt.

The tilt in conjunction with the table load produces a downhill-slope force, which has to be overcome by the operator of the medical examination table. If, for example, the brake is released by the operator in order to enable a manual movement of the table superstructure, the patient table would move to a mechanical end stop due to the downhill-slope force. In order to prevent the autonomous rolling motion, the operator must apply a counterforce of up to 100 N.

### SUMMARY AND DESCRIPTION

The present embodiments may obviate one or more of the drawbacks or limitations inherent in the related art. For example, in one embodiment, an apparatus and an associated method prevents an undesirable tilting of a medical examination table.

In one embodiment, a medical examination table includes a table top and at least one measuring device which measures an undesirable tilting of the table top produced by weight load or due to assembly and installation. The value of the measured tilt is used for automatic tilt compensation of the table top or for setting a predefinable tilt of the table top. The component of an undesirable weight load causing the tilt is compensated thereby.

In one embodiment, tilts of the table top, as a result of table loads due to patient weight and accessories, can be leveled out automatically. Assembly- or installation-related inclinations of the table top, caused, for example, by a floor surface gradient, can be automatically corrected thereby.

In one embodiment, the medical examination table can have at least one closed-loop control module controlling a tilt drive and a cant drive. Based on output signals of the at least one measuring device, the closed-loop control module can control the tilt and cant drive in such a way that the tilt of the table top can be compensated or adjusted. Accordingly, drives for medical examination tables can be easily and reliably used.

In one embodiment, the measuring device can include a tilt sensor which may be integrated into the table pedestal or table superstructure. This has the advantage that a tilt can be measured at different positions of the table.

In one development the closed-loop control module can include a frequency converter. This means that already existing frequency converters can also be used for control purposes.

The medical examination table may be a patient examination couch. Accordingly, patient loads can be counterbalanced.

In one example, an angiography workstation can be equipped with a medical examination table with tilt compensation. Accordingly, tilt compensation can also be used in angiography.

In one embodiment, a method for leveling a medical examination table having a table top is provided. An undesirable, weight-dependent tilt of the table top is measured and the tilt of the table top is automatically compensated based on the measured value or a predefinable tilt of the table top is set.

In one embodiment, a computer program product having a computer program which has software for performing the tilt compensation method when the computer program is executed in a closed-loop control module.

### BRIEF DESCRIPTION OF THE DRAWINGS

FIG. 1 shows one embodiment of a medical examination table,

FIG. 2 shows four views of a tilted medical examination table,

FIG. 3 shows one embodiment of a medical examination table with a tilt sensor,

FIG. 4 shows a block diagram of one embodiment of tilt compensation with a closed-loop control module, and

FIG. 5 shows a flowchart of one embodiment of tilt compensation.

### DETAILED DESCRIPTION

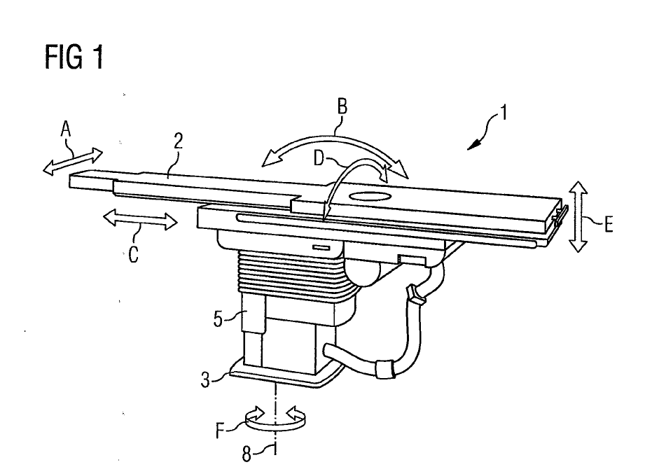

FIG. 1 shows a patient examination couch (table) 1. The patient examination table 1 includes a table top 2 that is arranged on a table pedestal 5 by one or more carriages. The table pedestal 5 is rotatably supported on a floor anchorage unit 3.

The table top 2 is movable in six degrees of freedom. Reference sign A denotes a transverse movement of the table top 2, B a tilting of the table top 2, C a longitudinal displacement of the table top 2, D a canting of the table top 2, E a raising and lowering of the table top 2, and F a rotating of the table top 2 about a vertical axis 8.

As a result of loading of the table top 2 with a weight (e.g., a patient weight and an accessory weight), for example, the table top may be inclined due to a tilting movement B and/or a canting movement D relative to the floor surface. In this case the canting D or, as the case may be, tilting B can occur at the transition of the table top 2 to the table pedestal 5 or else by tilting of the table pedestal 5 or, as the case may be, the lifting unit integrated therein.

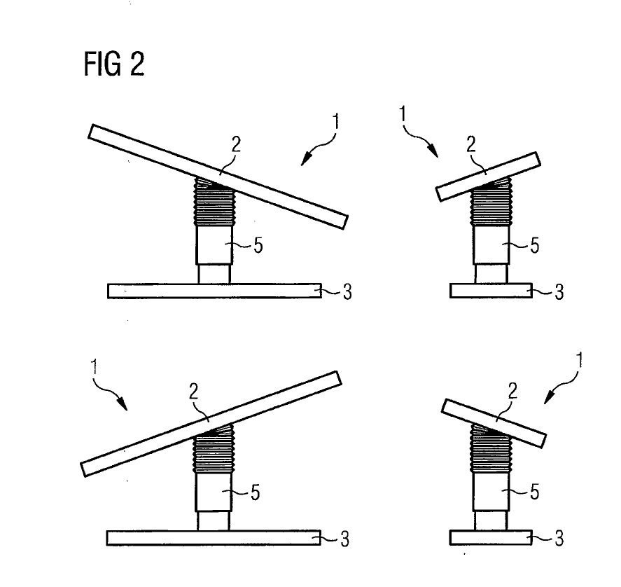

FIG. 2 shows by way of example the canting or tilting of the table top 2 of a medical examination table 1 at the transition between table top 2 and table pedestal 5 in four directions. The table top 2 inclines toward the floor anchorage unit 3 or the floor surface.

In one embodiment, one or more measuring devices 9, such as tilting sensors, may determine the tilt and supply the tilt to a closed-loop control module 10. The closed-loop control module 10 may control the tilt and cant drives of the medical examination table 1 to produce a compensation movement of the table top 2.

FIG. 3 shows a medical examination table 1 having a table top 2 which rests on a longitudinal and a transverse carriage 6, 7 and is displaceable parallel to the floor surface with the longitudinal and transverse carriages 6, 7. The longitudinal and transverse carriages 6, 7 are secured on a table pedestal 5 which includes a lifting unit 4 for raising and lowering the table top 2. The table pedestal 5 sits in a rotatably mounted manner on a floor anchorage unit 3 that ensures a permanent and stable connection of the medical examination table 1 to a floor. A measuring device 9, such as a tilt sensor, is mounted on the table pedestal 5 and can detect tilts of the table top 2 by measuring the deviations of the table pedestal 5 from the vertical. Optionally, or additionally, the measuring device 9 can also be integrated in the table top 2. The measuring device 9 determines a deviation of the surface of the table top 2 from the horizontal. The measured values, which are measured by the measuring device 9, are used for compensating the tilt of the table top 2.

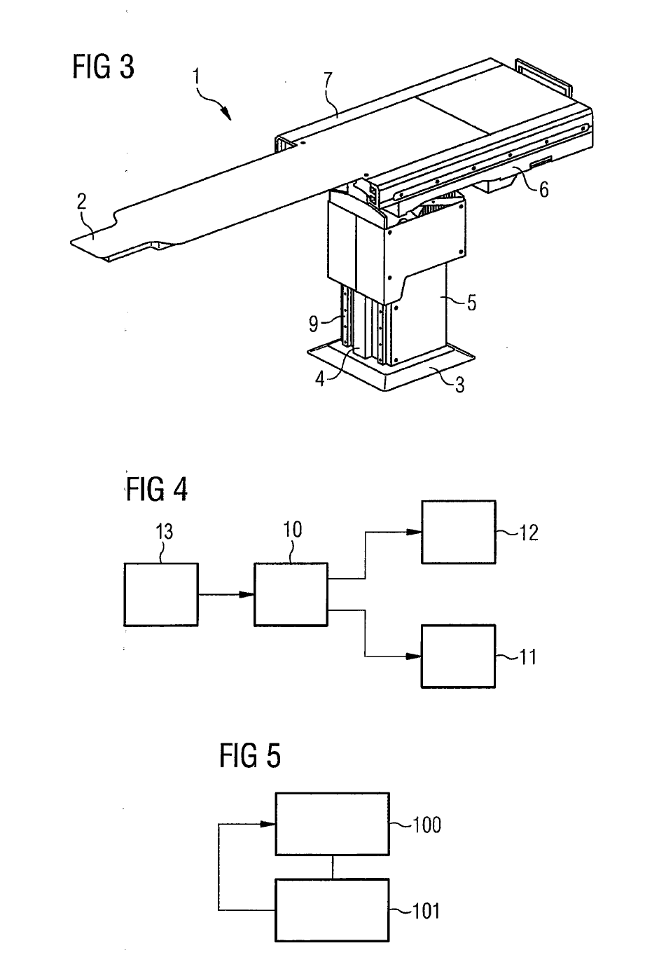

FIG. 4 shows a block diagram that illustrates tilt compensation. A measuring device 13 is connected to a closed-loop control module 10 which controls the cant drive 12 and the tilt drive 11 of a medical examination table. The measuring device 13 may constantly output control pulses to the closed-loop control module 10 until the measuring device 13 no longer measures any undesirable tilt. The closed-loop control module 10 evaluates the control pulses and sends corresponding control signals to the drives 11, 12 which steer the table top 2 into a horizontal position or a predefinable position.

FIG. 5 schematically illustrates the operating sequence of the method. In a first act 100, a weight-dependent or an undesirable assembly- or installation-related tilt of the table top 2 is measured. In act 101, the undesirable tilt of the table top 2 is automatically compensated based on the measured value, for example, by a closed-loop control module 10 and table drives 11, 12. Compensating for the undesirable tilt of the table top 2 may include leveling out the undesirable tilt of the table top 2. The method may run continuously in order to counterbalance any deviations of the table top 2 from the horizontal. The function of the closed-loop control module 10 can be realized by frequency converters that are present in medical examination tables.

In one embodiment, the tilt compensation can also be used to maintain an operator-predefinable tilt of the table top 2 irrespective of weight loadings caused by patients and accessory equipment.

Advantageously, the tilt compensation may be used during a table assembly or installation operation for the purpose of aligning the table top, for example, for leveling out any assembly- or installation-related tilts. Any irregularities and gradients in a floor surface that are due to manufacturing processes or assembly and installation can be automatically corrected.

Various embodiments described herein can be used alone or in combination with one another. The foregoing detailed description has described only a few of the many possible implementations of the present invention. For this reason, this detailed description is intended by way of illustration, and not by way of limitation. It is only the following claims, including all equivalents that are intended to define the scope of this invention.

1. A medical examination table comprising:
a table top for accommodating a patient; and
at least one measuring device that is operable to measure a tilting of the table top produced by a weight load or due to assembly or installation,
wherein the measured tilt is used for automatic tilt compensation of the table top or for setting a predefinable tilt of the table top.

2. The medical examination table as claimed in claim 1, further comprising at least one closed-loop control module that is operable to control a tilt drive and/or a cant drive, the at least one closed-loop control module is operable to control the tilt and cant drive in such a way that the tilt of the table top can be compensated or adjusted, the at least one closed-loop control module controlling the tilt and cant drive on the basis of the measure tilt.

3. The medical examination table as claimed in claim 1, wherein the measuring device includes a tilt sensor that is integrated into a table pedestal or a table superstructure or into the table top.

4. The medical examination table as claimed in claim 2, wherein the closed-loop control module includes a frequency converter.

5. The medical examination table as claimed in claim 1, wherein the medical examination table is a patient examination couch.

6. The medical examination table as claimed in claim 1, wherein the table top is a angiography table top used in an angiography workstation.

7. A method for leveling a table top of a medical examination table, the method comprising:
measuring a tilting of the table top induced by a weight load or due to assembly or installation, and
automatically compensating for the tilting of the table top based on the measured tilt or a predefinable tilt of the table top.

8. The method as claimed in claim 7, wherein the weight load includes the weight of a patient and/or of accessory equipment.

9. A computer program product having a computer program which has software for performing the following acts when the computer program is executed in a closed-loop control module or an external control unit:
measuring a tilting of the table top induced by weight load or due to assembly or installation, and
automatically compensating for the tilting of the table top based on the measured tilt or a predefinable tilt of the table top.
